(19) United States
(12) Patent Application Publication
(10) Pub. No.: US 2009/0255252 A1
(43) Pub. Date: Oct. 15, 2009

(54) HYDRODYNAMIC COUPLING WITH A SPEED PROTECTION MECHANISM AND TURBOCOMPOUND SYSTEM

(75) Inventor: Kurt Adleff, Crailsheim (DE)

Correspondence Address: BAKER & DANIELS LLP;111 E. WAYNE STREET, SUITE 800, FORT WAYNE, IN, 46802, US

(73) Assignee: VOITH TURBO GMBH & CO. KG, Heidenheim (DE)

(21) Appl. No.: 11/569,392

(22) PCT Filed: Jun. 15, 2005
(86) PCT No.: PCT/EP05/06380

§ 371 Date: Apr. 14, 2009

(30) Foreign Application Priority Data
Jun. 18, 2004 (DE) 10 2004 029 656.1

(51) Int. Cl. F16D 33/06; F02G 3/00

(52) U.S. Cl. 60/624; 60/347

(57) ABSTRACT

The invention relates to a hydrodynamic coupling, especially for a turbocompound system, comprising:
a pump wheel;
a turbine wheel which forms in combination with a pump wheel a working chamber which can be filled with a working medium.

The hydrodynamic coupling in accordance with the invention is characterized in that

a mechanical locking device is provided for connecting the pump wheel and the turbine wheel in a torsionally rigid manner, which locking device is in connection with a section of the coupling guiding a working medium such that it closes under a predetermined degree of filling of the working chamber.

The present invention relates to a hydrodynamic coupling, especially for a turbocompound system, and especially a turbocompound system with a hydrodynamic coupling.

The hydrodynamic coupling in such a turbocompound system is used for transmitting torque from an exhaust gas utilization turbine arranged in the exhaust gas flow of an internal combustion engine to the crankshaft driven by the internal combustion engine in order to thus increase the efficiency of the drive train. Because the crankshaft is driven by the exhaust gas utilization turbine via the hydrodynamic coupling, there is naturally a torque support of the utilization turbine which prevents any uncontrolled revving up of the exhaust gas utilization turbine. If for any reason (e.g. by loss of filling in the coupling circulation) said torque support should be limited or cut off, there is a likelihood that the exhaust gas utilization turbine will reach an overspeed range and be damaged.

A loss of filling in the coupling circulation, which means a loss of working medium which is revolved in the working medium of the hydrodynamic coupling, may occur for example by damage to the coupling shell (fracture or the like) as a result of a defect in material or operating error. Even if measures are taken in order to protect the coupling from total loss in case of such damage, such a damage would lead in a turbocompound system to the described overspeed of the exhaust gas utilization turbine and damage the latter. In order to avoid this, speed monitoring of the utilization turbine has been provided conventionally, which upon determining an overspeed will initiate suitable measures such as the switching of a bypass around the exhaust gas utilization turbine because other measures like cutting off the exhaust gas flow driving the exhaust gas utilization turbine which could only occur by switching off the engine is not practicable.

A further disadvantage can be seen in the respect that the active speed monitoring requires outside power.

The invention is based on the object of providing a hydrodynamic coupling and especially a turbocompound system with a hydrodynamic coupling in accordance with the invention which is improved over the state of the art and especially offers an automatic overspeed protection without requiring outside power.

This object is achieved by a hydrodynamic coupling with the features of claim 1 and by a turbocompound system with the features of claim 10. The sub-claims describe especially advantageous embodiments of the invention.

The hydrodynamic coupling in accordance with claim 1 comprises the usual components such as a pump wheel and a turbine wheel which jointly form a working chamber. Said working chamber is filled or can be filled with a working medium. A working medium circulation is provided for supplying and discharging working medium to and from the working chamber, which circulation is also called coupling circulation.

In accordance with the invention, the hydrodynamic coupling comprises a locking device which is capable of locking the pump wheel and the turbine wheel against one another in a torsionally rigid manner. Said locking device is in connection with a section of the coupling which bears working medium, e.g. between the pump wheel and the turbine wheel, especially between an outer shell of the pump wheel which encloses the turbine wheel on its rear side, such that it closes beneath a predetermined degree of filling of the working chamber, with the degree of filling having an effect in a (partial) filling or discharging of the section guiding the working medium. Closing within the terms of the present invention means a torsionally rigid locking of pump wheel and turbine wheel on one another. The closing advantageously occurs in an automatic manner, which means without any manual actuation caused from outside of the coupling, especially automatically under the influence of centrifugal force which occurs necessarily during the operation of the hydrodynamic coupling. The mechanical locking device is advantageously configured in form of a lock-up clutch which engages and disengages automatically, especially under the influence of centrifugal force which occurs necessarily during the operation.

The mechanical locking device can be arranged in an especially advantageous manner in such a way that in addition to its monitoring function for the degree of filling of the working chamber it simultaneously represents an overspeed protection for the hydrodynamic coupling. It is arranged in this case (e.g. by providing a centrifugal force element, i.e. an element with a predetermined mass which displaces radially to the outside by centrifugal force above a predetermined speed) in such way that it closes above a predetermined speed of the pump wheel or the turbine wheel. In this case too, the closing of the locking device which is advantageously arranged as a lock-up clutch occurs especially automatically, which means that the lock-up clutch automatically engages and disengages under the influence of centrifugal force which occurs necessarily during the operation.

Especially when using the hydrodynamic coupling in accordance with the invention in a turbocompound system, the locking of the locking device, which means the mechanical coupling of the exhaust gas utilization turbine speed to the crankshaft speed, will lead to the consequence that the components of the exhaust gas utilization turbine are securely protected from destruction by overspeed. In the case that the hydrodynamic coupling fails between exhaust gas utilization turbine speed and crankshaft speed, a mechanical connection takes its place. This can be a connection of the outside part of the coupling, i.e. the shell of the pump wheel, with the inside wheel, i.e. the turbine wheel.

The coupling shell which revolves at pump speed by the connection with the pump wheel can be connected for example via a gear transmission, which is usually a wheel gear, with the utilization turbine, whereas the inside wheel, which is the turbine wheel, is connected with the crankshaft via a gear transmission, which is usually a wheel gear. A bolt which is displaceable in the radial direction of the coupling can be arranged between the coupling shell and the inside wheel and further an opening with which the bolt is in alignment. The bolt engages in the opening or through the same in a first locking position when the mechanical locking device closes. In a second position, i.e. the opened position of the locking device, the bolt is situated completely outside of the opening. The question whether the bolt engages in the opening or not is determined by the degree of filling in the working chamber in such a way that in the case that the locking device is opened the working medium will exert a displacing force on the bolt, so that the bolt is displaced out of the opening. In the case that the locking device is closed, said displacing working medium is not present in the respective section guiding the working medium and the bolt is pressed by a suitable pressing means such as a pressure spring into the opening or through the same.

The following forces act especially upon the bolt in operation:
the centrifugal force F_{Z}=mω²r with:
   m: mass (kg)
   ω: angular velocity (1/s)
   r: circular path radius (m);
the spring force (restoring force) F_{R}=−kx with:
   k: spring constant (N/m)
   x: deflection (m);
the force by the rotational pressure on the radially outside face surface of the bolt FP=A_{Bolzen} ρ/2 ω² (r_{wlrk}²-r_{FR}²) (N) with:
   A_{Bolzen}: radially outside face surface of bolt (m²)
   ρ: density of working medium (kg/m³)
   ω: angular velocity (1/s)
   r_{wlrk}²: radius on which rests the outer face surface of the bolt (m)
   r_{FR}: inside diameter of the liquid ring in the working chamber (m)
the lifting force (in the rotating space) F_{A,rot}=ρaᵣₒₜV with:
   ρ: density of working medium (kg/m³)
   aᵣₒₜ=ω²r centripetal acceleration (m/s²)
   V: volume of the working medium displaced by bolt (m³).

In normal operation, i.e. outside of operation critical for exhaust gas utilization turbine or hydrodynamic coupling, the following applies:

F_{Z}<F_{R}+F_{ρ}+F_{A,rot}

The bolt thus remains securely in its provided position outside of engagement with the opening at every speed of normal operation.

When the filling level of the coupling drops, the rotation pressure Fₚᵤ and/or the lifting force thus decreases. The relationship of the forces on the bolt thus change:

F_{Z}>F_{R}+F_{ρ}+F_{A,rot}

The centrifugal force F_{Z} is thus higher than the forces opposing it, which leads to the consequence that the bolt slides into the opening and locks the pump wheel and turbine while against one another in a torsionally rigid manner. The same movement of the bolt also occurs when the lifting force is still present, but the centrifugal force F_{Z} rises to such an extent as a result of overspeeds that it overcomes the forces opposing it despite the comparatively high lifting force.

When using the hydrodynamic coupling in a turbocompound system, a mechanical coupling is produced between the crankshaft and the exhaust gas utilization turbine.

For reasons of simplicity, calculations were performed in the above equations with an acting pressure spring force. It is understood that it is possible to use any pressure means which is capable of exerting a force on the bolt against the centrifugal force. When using such a pressure spring it is advantageous to configure the spring in such a way that the bolt is held in the radial inside position at low speeds of the turbine (e.g. during starting), whereas in the case of an overspeed it will slide radially to the outside even in the case of a filled circulation in order to protect the turbine from longer operation with said overspeed.

In accordance with one embodiment, the bolt engages after the entrance into the opening in order to produce an emergency synchronization between crankshaft and exhaust gas utilization turbine which is maintained until the bolt is manually unlatched again. According to another embodiment, the bolt is returned automatically after the standstill of the engine to its original position, i.e. its radially inside position.

According to a further embodiment of the invention, no “floating” bolt is arranged between coupling shell and inside wheel, but a “floating” rocker arm is provided. Said rocker arm can work according to the aforementioned functional principle of the bolt, i.e. it can assume a first position at which the turbine wheel can turn relative to the pump wheel or the inside wheel relative to the coupling shell, and a second position at which the rocker arm locks the pump wheel and turbine wheel or the inside wheel and coupling shell in a torsionally rigid manner with each other.

The rocker arm and its counterpart, e.g. in the form of an opening into which the rocker arm engages, can be provided like the bolt described above in the section between the coupling shell and the rear side of the turbine wheel. It is understood that such a rocker arm can also be arranged between two mutually facing coupling wheels, generally the primary wheel (pump wheel) and the secondary wheel (turbine wheel), and be arranged for a locking in predetermined states of the two. The position of the rocker arm is advantageously set according to the arrangement of the bolt by the filling level of the coupling, the centrifugal force on the rocker arm, a spring force on the rocker arm and the rotation pressure on the rocker arm.

The invention is now explained in closer detail by reference to embodiments, wherein:

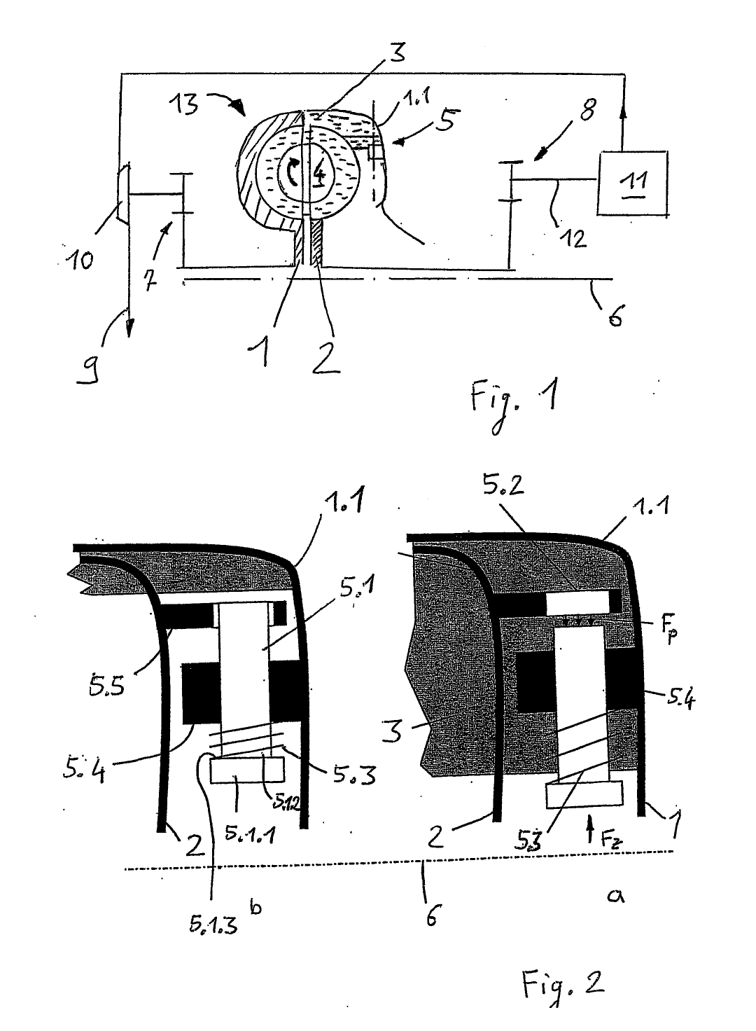

FIG. 1 shows a hydrodynamic coupling in a turbocompound system;

FIG. 2 shows the details of the hydrodynamic coupling arranged in accordance with the invention in FIG. 1 in an opened state (FIG. 2a) and in a closed (locked) state (FIG. 2b);

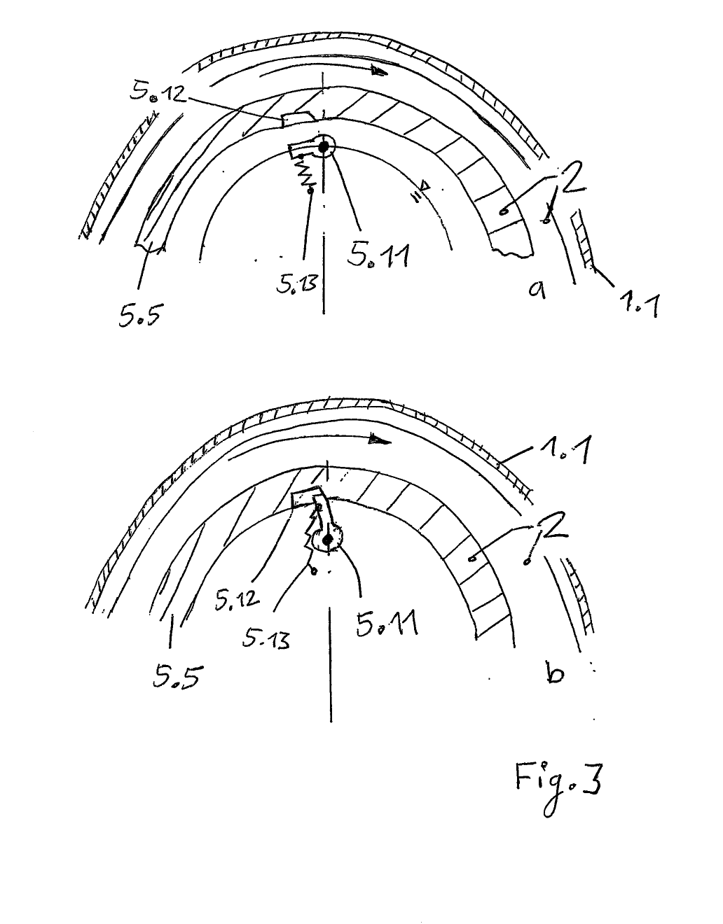

FIG. 3 shows a further hydrodynamic coupling arranged in accordance with the invention in an opened state (FIG. 3a) and in a closed (locked) state (FIG. 3b);

FIG. 1 shows the hydrodynamic coupling 13 which is arranged in driving connection between the crankshaft driven by the internal combustion engine 11 and the exhaust gas utilization turbine 10 charged with the exhaust gas of the internal combustion engine 11. The hydrodynamic coupling 13 comprises a pump wheel 1 and a turbine wheel 2. The pump wheel 1 is in driving connection with the exhaust gas utilization turbine 10 via the gear transmission 7. The turbine wheel 2 is in driving connection with the crankshaft 12 via the gear transmission 8.

Reference numeral 9 indicates the guidance of the exhaust gas flow.

The pump wheel 1 and the turbine wheel 2 jointly form a working chamber 4 in which the working medium 3 circulates, as indicated by the direction of circulation by the arrow in the working chamber 4. The working medium 3 is accelerated radially to the outside by the pump wheel 1 and delayed radially to the inside by the turbine wheel 2. Torque is transmitted via the circulatory flow of the working medium 3 from the pump wheel 1 to the turbine wheel 2.

The working medium 3 is supplied for example in the center or approximately in the center of the working medium circulation (not shown) and discharged from the working chamber 4 radially to the outside to a region between the rear side of the turbine wheel 2, i.e. the side which is opposite of the working chamber 4, and an outer shell 1.1 which is connected with the pump wheel 1 in a torsionally rigid manner and encloses the turbine wheel 2. This discharging is always obtained when there is a partial or complete discharging of the working chamber 4. A respective level of working medium will be obtained in the region between the turbine wheel 2 and the outside shell 1.1 even in the case that a constant quantity of working medium 3 is located in the working chamber 4.

FIG. 2 again shows a schematic detailed view of the section of FIG. 1 in which the locking device in accordance with the invention is arranged. The rotational axis 6 of the hydrodynamic coupling is indicated both in FIG. 1 as well as in FIG. 2 by means of the dot-dash line.

FIG. 2 clearly shows the level of the working medium 3 in the region of the mechanical locking device 5, with “normal operation” being shown in FIG. 2a and an operating state in FIG. 2b in which for some reason the working medium has leaked unintentionally from the hydrodynamic coupling.

In FIG. 2a, the bolt is situated in its radially inside position and thus outside of opening 5.2 as a result of the force of spring 5.3, the rotation pressure (force F_{B}) applied to the radially outside face surface of bolt 5.1 and the lifting force of the working medium 3, into which the bolt is nearly completely immersed with its shaft 5.1.2, with only the rotation force F_{Z} being directed against these forces. A relative rotational speed (slip of the coupling) is enabled between the pump wheel 1 and the turbine wheel 2.

According to FIG. 2, however, both the lifting force as well as the rotational pressure on the radially outside face surface of bolt 5.1 is omitted as a result of the working medium level which is displaced radially to the outside against the operating state which is shown in FIG. 2a. The centrifugal force F_{Z} overcomes the spring force of spring 5.3 and pushes the bolt 5.1 with the radially outer end into the opening 5.2. A mechanical locking will be produced between outer shell 1.1 and turbine wheel 2 and thus between pump wheel 1 and the turbine wheel 2. As a result, the exhaust utilization turbine 10, which means the blade wheel of the same, is mechanically coupled with respect to its speed to the crankshaft 12, with the absolute speed of the exhaust gas utilization turbine 10 being obtained according to the gear ratios of the interposed gear transmissions 7 and 8.

As is shown in FIG. 2, the opening 5.2 is introduced according to the shown embodiment into a projection 5.5 which is formed on the rear side of the turbine wheel 2. Bolt 5.1 slides with its cylindrical shaft 5.1.2 within a guide means 5.4 which encloses the shaft 5.1.2 in the circumferential direction. An enlarged head section 5.1.1, which means it is provided with a larger diameter, is connected radially to the inside of the shaft 5.1.2. As a result of the portion of the head section 5.1.1 protruding over the shaft 5.1.2, a shoulder 5.1.3 is formed radially on the outside of the head section 5.1.1, on which the spring 5.3 acts with its radially inner axial end. The spring 5.3 engages with its opposite radially outer axial end on the guide means 5.4. Since spring 5.3 is arranged as a pressure spring, it thus exerts a force in the radial direction towards the inside on the bolt 5.1.

FIG. 3 shows a locking mechanism which is modified as compared with FIGS. 1 and 2, once in the opened state (FIG. 3a) and once in the locked state (FIG. 3b). FIG. 3 shows two sectional views in a radial sectional view approximately through the position of the longitudinal axis of the bolt in FIGS. 1 and 2, although obviously no bolt is provided in the embodiment according to FIG. 3.

In this sectional view one can see as the component of the pump wheel 1 only the rocker arm 5.11 connected to the inside on the outer shell 1.1 and a section of the radial intersecting surface through the outer shell 1.1 in a radially outside region.

Only a sectional view through the axial projection 5.5 is shown of the turbine wheel 2, in which projection the opening 5.12 is formed as the counterpart to the rocker arm, and the outside shape of the turbine wheel 2.

As is shown, a rocker arm 5.11 which is linked to the pump wheel 1 instead of the bolt, which rocker arm can be pivoted radially to the outside about an axis parallel to the rotational axis of the coupling. The rocker arm 5.11 is held in the position as shown in FIG. 3a against the force of the pressure spring 5.13 and the centrifugal force by the lifting force of the working medium (see the illustrated liquid level).

When the degree of filling decreases, as a result of which the indicated liquid level migrates radially to the outside and the lifting force on the rocker arm 5.11 decreases, the rocker arm 5.11 moves as a result of the force of the pressure spring 5.13 to the second position as shown in FIG. 3b.

In the case of a respectively high centrifugal force by a high speed of the pump wheel 1, which occurs especially in such a way that no braking torque is transmitted by the turbine wheel 2 especially because the coupling is substantially or completely discharged of working medium, the centrifugal force will also tilt the rocker arm 5.11 in a direction radially to the outside in the direction towards a recess or opening in the turbine wheel 2 or into a projection provided on the same. The rocker arm 5.11 engages in said opening 5.12, so that the pump wheel 1 will entrain the turbine wheel 2, which pump wheel rotates in the direction of rotation as indicated by the arrow.

It is understood that it is also possible that only the liquid level and thus the degree of filling of the coupling will determine the position of the rocker arm 5.11 when the rocker arm is provided with such a light configuration that the influence of the centrifugal force is negligible.

A possible embodiment of the invention, advantageously in the form shown according to FIG. 2, is analyzed in a computational manner.

For example, an aluminum weight (especially in the form of the described bolt 5.1) can have a diameter of 10 mm and a length of 200 mm. All dimensions in this description shall be regarded as preferable values which are maintained advantageously in an approximate manner. The aluminum weight is immersed to 75% in the working medium when the hydrodynamic coupling is in the nominal state, i.e. the level does not fall beneath a predetermined degree of filling. The system can be tuned with the help of a suitable spring in such a way that at a speed of 8586 per minute for example the piston will extend, which means the mechanical locking device will close. An overspeed of more than 8586 per minute will be prevented. If however the degree of filling of the working chamber in the coupling will decrease, a reduced lifting force will act and thus only the spring force applied to the bolt will act against the centrifugal force acting upon the bolt. The closing of the mechanical locking device therefore occurs at an earlier time, e.g. within the normal operating range of the hydrodynamic coupling, which means within a speed range which is permissible when the coupling is filled or at a predetermined degree of filling of the working chamber of the coupling.

At a density of the employed aluminum for the locking device or the bolt of 0.00265 g per mm³, a lifting force acting on the bolt of 56.1 newtons is obtained at an angular speed of 900 per second. The restoring force by the rotational pressure in the working medium on the bolt is 74.8 newtons. The centrifugal force is 236 newtons in this embodiment and the spring force is especially 105.1 newtons. This leads to a closing of the locking device above 8586 revolutions per minute, which corresponds to the mentioned angular velocity of 900 per second.

In the case of a loss of oil however, both the lifting force as well as the restoring force is equal zero by the rotational pressure. This leads to a switching speed of 4730 per minute. An overspeeding of the turbine is thus reliably prevented.

### LIST OF REFERENCE NUMERALS

1 Pump wheel

1.1 Outer shell

2 Turbine wheel

3 Working medium

4 Working chamber

5 Mechanical locking device

5.1 Bolt

5.1.1 Head section

5.1.2 Shaft

5.1.3 Shoulder

5.2 Opening

5.3 Pressure spring

5.4 Guide means

5.5 Projection

5.11 Rocker arm

5.12 Opening

5.13 Pressure spring

6 Rotational axis of coupling

7 Gear transmission

8 Gear transmission

9 Exhaust gas guidance

10 Exhaust gas utilization turbine

11 Internal combustion engine

12 Crankshaft

13 Hydrodynamic coupling

1. A hydrodynamic coupling, especially for a turbocompound system, comprising:
a pump wheel;
a turbine wheel which forms with the pump wheel a working chamber which can be filled with a working medium;
characterized in that
a mechanical locking device is provided for connecting the pump wheel and the turbine wheel in a torsionally rigid manner, which locking device is in connection with a section of the coupling guiding a working medium that it closes under a predetermined degree of filling of the working chamber.

2. A hydrodynamic coupling according to claim 1, characterized in that the mechanical locking device is arranged in such a way that it further closes above a predetermined speed of the pump wheel or the turbine wheel.

3. A hydrodynamic coupling according to claim 1, characterized by the following features:
the mechanical locking device comprises a bolt which is displaceable in the radial direction of the coupling and an opening which can be engaged by the bolt;
the bolt is connected in a torsionally rigid manner to one of the two wheels, especially the pump wheel, and the opening is arranged in the other wheel, especially the turbine wheel;
the bolt is immersed at and above the predetermined degree of filling of the working medium in such a way that it is pressed out of the opening at least under participation of the lifting force (F_{A}) of the working medium;
a pressure means, especially a pressure spring, is provided which acts on the bolt against the lifting force (F_{A}) of the working medium, so that the bolt engages in the opening beneath the predetermined degree of filling.

4. A hydrodynamic coupling according to claim 3, characterized in that the bolt has a cylindrical shape and its longitudinal axis stands perpendicular to the rotational axis of the coupling.

5. A hydrodynamic coupling according to claim 3, characterized in that the pump wheel comprises an outer shell which encloses the turbine wheel on its side averted from the working chamber and such that the mechanical locking device is arranged in the space between the outer shell and the turbine wheel.

6. A hydrodynamic coupling according to claim 5, characterized in that the bolt slides in a guide means which is fastened to the outer shell is arranged integrally with the same, and such that the opening is arranged in a projection on the turbine wheel, especially in alignment with the guide means.

7. A hydrodynamic coupling according to claim 6, characterized in that the bolt is provided on its radially inner end with a head section which has an outside diameter which is enlarged relative to a radially externally adjacent shaft of the bolt, so that a shoulder is formed, and that a pressure spring which is provided as a pressure means rests on said shoulder and radially opposite on the guide means.

8. A hydrodynamic coupling according to claim 3, characterized in that the pressure spring has such a spring force (F_{R}) and the bolt has such a mass (m) that the mechanical locking device closes above the predetermined speed irrespective of the degree of filling of the working chamber.

9. A hydrodynamic coupling according to claim 1, characterized by the following features:
the mechanical locking device comprises a rocker arm which can be pivoted in the radial direction of the coupling and an opening which can be engaged by the rocker arm;
the rocker arm is connected in a stationary manner to one of the two wheels, especially the pump wheel, and the opening is arranged in the other wheel, especially the turbine wheel;
the rocker arm is immersed at and above the predetermined degree of filling in the working medium in such a way that it is pressed out of the opening at least under participation of the lifting force (F_{A}) of the working medium;
a pressure means, especially a pressure spring, is provided which acts on the rocker arm against the lifting force (F_{A}) of the working medium, so that the rocker arm engages in the opening beneath the predetermined degree of filling.

10. A hydrodynamic coupling according to claim 1, characterized in that the mechanical locking device is provided with a means which after the closing keeps the locking device closed until a manual actuation.

11. A turbocompound system with an exhaust gas utilization turbine which is arranged in the exhaust gas flow of an internal combustion engine, with
the internal combustion engine driving a crankshaft, and
the exhaust gas utilization turbine being switched or switchable into a driving connection with the crankshaft;
a hydrodynamic coupling according to claim 1 being arranged in the driving connection, whose pump wheel is in a driving connection with the exhaust gas utilization turbine and whose turbine wheel is in a driving connection with the crankshaft.

12. A hydrodynamic coupling according to claim 2, characterized by the following features:
the mechanical locking device comprises a bolt which is displaceable in the radial direction of the coupling and an opening which can be engaged by the bolt;
the bolt is connected in a torsionally rigid manner to one of the two wheels, especially the pump wheel, and the opening is arranged in the other wheel, especially the turbine wheel;
the bolt is immersed at and above the predetermined degree of filling of the working medium in such a way that it is pressed out of the opening at least under participation of the lifting force (F_{A}) of the working medium;
a pressure means, especially a pressure spring, is provided which acts on the bolt against the lifting force (F_{A}) of the working medium, so that the bolt engages in the opening beneath the predetermined degree of filling.

13. A hydrodynamic coupling according to claim 4, characterized in that the pump wheel comprises an outer shell which encloses the turbine wheel on its side averted from the working chamber and such that the mechanical locking device is arranged in the space between the outer shell and the turbine wheel.

14. A hydrodynamic coupling according to claim 7, characterized in that the pressure spring has such a spring force (F_{R}) and the bolt has such a mass (m) that the mechanical locking device closes above the predetermined speed irrespective of the degree of filling of the working chamber.

15. A hydrodynamic coupling according to claim 2, characterized by the following features:
the mechanical locking device comprises a rocker arm which can be pivoted in the radial direction of the coupling and an opening which can be engaged by the rocker arm;
the rocker arm is connected in a stationary manner to one of the two wheels, especially the pump wheel, and the opening is arranged in the other wheel, especially the turbine wheel;
the rocker arm is immersed at and above the predetermined degree of filling in the working medium in such a way that it is pressed out of the opening at least under participation of the lifting force (F_{A}) of the working medium;
a pressure means, especially a pressure spring, is provided which acts on the rocker arm against the lifting force (F_{A}) of the working medium, so that the rocker arm-engages in the opening beneath the predetermined degree of filling.

16. A hydrodynamic coupling according to claim 2, characterized in that the mechanical locking device is provided with a means which after the closing keeps the locking device closed until a manual actuation.

17. A hydrodynamic coupling according to claim 3, characterized in that the mechanical locking device is provided with a means which after the closing keeps the locking device closed until a manual actuation.

18. A hydrodynamic coupling according to claim 4, characterized in that the mechanical locking device is provided with a means which after the closing keeps the locking device closed until a manual actuation.

19. A hydrodynamic coupling according to claim 5, characterized in that the mechanical locking device is provided with a means which after the closing keeps the locking device closed until a manual actuation.

20. A hydrodynamic coupling according to claim 6, characterized in that the mechanical locking device is provided with a means which after the closing keeps the locking device closed until a manual actuation.
